(19) United States
(12) Patent Application Publication
(10) Pub. No.: US 2020/0018094 A1
(43) Pub. Date: Jan. 16, 2020

(54) Lock Apparatus

(71) Applicant: Scott A. Densmore, Littleton, CO (US)

(72) Inventor: Scott A. Densmore, Littleton, CO (US)

(21) Appl. No.: 16/578,329

(22) Filed: Sep. 21, 2019

Related U.S. Application Data
(63) Continuation-in-part of application No. 15/822,118, filed on Nov. 25, 2017, now Pat. No. 10,458,149.
Application No. 15/822,118 is a continuation-in-part of application No. 14/513,546, filed on Oct. 14, 2014, now abandoned.
(60) Provisional application No. 62/031,270, filed on Jul. 31, 2014.

(51) Int. Cl. E05B 17/20; E05B 63/00; E05B 9/08

(52) U.S. Cl. CPC E05B 17/2038; E05B 63/0017; E05B 9/02; E05B 17/2003; E05B 17/2084; E05B 9/084

(57) ABSTRACT

A lock and method of use for securing and un-securing first and second articles, the lock comprises a first element rotationally engaged about a longitudinal axis to the first article, an extension beam rotationally engaged about a lengthwise axis to the first article, the lengthwise and longitudinal axes are coincident, the beam has structure to rotationally engage and disengage the first element. Also included is structure to engage and disengage the second article that is driven from the beam, wherein operationally the beam rotationally engages the first element and the extension beam engages and disengages the first and second articles, resulting in the beam always being able to engage and disengage the first and second articles and the first element only having an ability to engage and disengage the first and second articles when the first element and the beam are rotationally engaged to one another.

### RELATED PATENT APPLICATIONS

This is a continuation in part (CIP) patent application of U.S. patent application Ser. No. 15/822,118 filed on Nov. 25, 2017 by Scott A. Densmore of Littleton, Colo., US, that is a continuation in part (CIP) patent application of U.S. patent application Ser. No. 14/513,546 (now abandoned) filed on Oct. 14, 2014 by Scott A. Densmore of Sedalia, Colo., US, that in turn claims the benefit of U.S. provisional patent application Ser. No. 62/031,270 filed on Jul. 31, 2014 by Scott A. Densmore of Sedalia, Colo., U.S.

### FIELD OF THE INVENTION

The present invention generally relates to locks that interface between a first article and a second article. More particularly, the present invention discloses a deadbolt type lock that interfaces between a door and a door frame.

### DESCRIPTION OF THE RELATED ART

Prior art typical deadbolt locks are typically constructed of an exterior key lock cylinder that is rotationally coupled to the bolt assembly that has a mechanism to convert the rotational movement from the lock cylinder into reciprocating movement in the bolt assembly that moves into and out of the door frame, wherein the lock cylinder is rotationally engaged to the door, thus with the bolt extension assembly extended into the door frame this results in the door being locked to the door frame. Further included in the typical deadbolt lock is an interior thumb turn handle that is also rotationally engaged to the door and the bolt extension assembly like the key lock cylinder except that the thumb turn handle can manually place the bolt assembly extended into or retracted out of the door frame.

One of the security concerns with the deadbolt lock is on the key lock cylinder that is on the external side of the door, wherein a person with evil intent would try to breach the lock cylinder with a master key or even a locksmiths key picking ratchet to have the key lock cylinder rotate as though the evil intent person had the correct key to turn the lock cylinder, thus being able to rotate the key lock cylinder and resulting in the bolt extension assembly withdrawing from the door frame and effectively unlocking the door without using the correct key, thus emphasizing that the unique configuration of the key is not much of a barrier for a motivated and resourceful criminal to overcome the typical prior art dead bolt lock. One possible solution to removing the weak deterrent effect of requiring a unique key to rotate the key lock cylinder is to be able to selectively rotationally disconnect the rotational engagement of the key lock cylinder from the bolt extension assembly all from the inside portion of the door via the thumb turn handle, thus resulting that if the key lock cylinder is overcome with a bogus key or even in the case of the criminal having the correct key, being irrelevant toward overcoming dead bolt in retracting the bolt extension assembly from the door frame and being able to open the door.

Further, even if a criminal were to use the incorrect key in the key lock cylinder and impart excessive rotational force, bump, or even drill out the key lock cylinder to overcome the key lock cylinder not rotating from the wrong key being in it would also be irrelevant as the key lock cylinder is rotationally disengaged from the bolt assembly thus resulting in the dead bolt remaining locked no matter what happens to the key lock cylinder. Even with an electronic key, there could be an instance of it being hacked and being overcome as if the criminal had the correct key code would still not allow the dead bolt to become un-locked-truly making the lock apparatus a “dead” bolt, wherein the bolt cannot be changed from its locked positional state via the exterior key lock cylinder.

In looking at the prior art in this area, starting with U.S. Pat. No. 7,207,199 to Smith, et al., disclosed is a deadbolt mechanism including a lock out mechanism that functions to disable the operation of the deadbolt from at least one side of the deadbolt mechanism. In Smith '199 the deadbolt mechanism includes a deadbolt, key cylinder, housing, turn knob and a shaft that connects the key cylinder and turn knob. To place the deadbolt mechanism in Smith '199 into lock out mode, the turn knob is moved to the locked positioned and then pulled outward away from the door. By pulling the knob outward, the shaft engages a portion of the housing which prevents rotation of the shaft and thereby prevents movement of the deadbolt from the locked position. A problem with Smith '199 is that a mechanical rotational lockout effectuates the rotational lock-up of the shaft between the thumb turn handle and the key lock cylinder with the bolt assembly rotationally disposed therebetween, wherein if excessive rotational force is applied externally to the key lock, it could overcome the rotational lock which would breach the entire deadbolt lock, thus a better design would have the rotational disengagement of the key lock assembly thus allowing the key lock assembly to rotationally “free wheel” in relation to the bolt assembly and the thumb turn handle such that if excessive rotational force is applied to the key lock assembly to breach the dead bolt lock it would not matter.

Further in the dead bolt lock prior art in U.S. Pat. No. 7,712,343 to Smith, et al., disclosed is a deadbolt mechanism including a lock out mechanism (100) that functions to disable the operation of the deadbolt from at least one side of the deadbolt mechanism. The deadbolt mechanism in Smith '343 includes a deadbolt, key cylinder, housing, turn knob and a shaft that connects the key cylinder and turn knob. In Smith '343 to place the deadbolt mechanism in lock out mode, a release mechanism is actuated and the turn knob is pulled outward away from the door.

Further in Smith '343, by pulling the knob outward, the shaft engages a portion of the housing which prevents rotation of the shaft and thereby prevents movement of the deadbolt from the lock-out position. Again as in Smith '199, Smith '343 has the problem in that a mechanical rotational lockout effectuates the rotational lock-up of the shaft between the thumb turn handle and the key lock cylinder with the bolt assembly rotationally disposed therebetween, wherein if excessive rotational force is applied externally to the key lock, it could overcome the rotational lock which would breach the entire deadbolt lock, thus a better design would have the rotational dis-engagement of the key lock assembly thus allowing the key lock assembly to rotationally “free wheel” in relation to the bolt extension assembly and the thumb turn handle such that if excessive rotational force is applied to the key lock assembly to breach the dead bolt lock it would not matter.

Continuing in the deadbolt lock prior art, in U.S. Pat. No. 6,729,169 to Moore disclosed is a deadbolt manipulation adjunct and method that provides user selection between dual cylinder, single cylinder, and disabled modes, is capable of retrofitting on existing deadbolt structures, which maintains full deadbolt security while providing authorized user deadbolt operation between locked and unlocked positions via a thumb turn actuator to release the deadbolt in the case of an emergency. Moore '169 provides especially the emergency opening release of the key locked interior deadbolt type lock, wherein the dead bolt lock can be selectively set to function as a conventional non-key required interior thumb type turn handle to facilitate emergency exit situations wherein a key would not be easily available to open the dead bolt lock from inside the building structure.

Next in the dead bolt lock prior art area in U.S. Pat. No. 7,748,244 to Garza, et al., disclosed a lock assembly for use with a bolt movable from a retracted position to an extended position from outside the house. The lock assembly in Garza includes an exterior assembly and an interior assembly having an interior actuator manually operable to move the bolt extension between the retracted position and the extended position. The exterior assembly in Garza includes an exterior actuator manually operable to cause the bolt extension to move from the retracted position to the extended position and inoperable to move the bolt extension from the extended position to the retracted position. Thus the result in Garza is that the exterior portion of the dead bolt has an added actuator that functions to only lock the dead bolt without the need for a key.

Further in the dead bolt lock prior art area in U.S. Pat. No. 5,421,074 to Moore, disclosed is a conversion kit allows a user to convert a deadbolt lock mechanism into a pick proof deadbolt lock mechanism by providing all the necessary parts allowing a user to easily and effectively prevent the turn piece latch of the deadbolt lock mechanism from rotating. Once installed in Moore '074, a locking shaft pin of the kit can be placed into a first orifice drilled through the turn piece latch and a second orifice, coaxially aligned with the first orifice, drilled through the back plate to immobilize the turn piece latch in its locked position from the interior side of the dead bolt lock, further it would also allow a deadbolt manufacturer to use the same, in which case collars could be an O-ring style.

In Moore '074 there is the same issue as with Smith '199 and Smith '343 in that the problem is with the mechanical fixed rotational lockout via rod 6, that effectuates the rotational lock-up of the shaft between the thumb turn handle and the key lock cylinder with the bolt assembly rotationally disposed and bolt extension assembly locked therebetween, wherein if excessive rotational force is applied externally to the key lock, it could overcome via rotationally overloading the rotational lock which would breach the entire deadbolt lock, thus again a better design would have the rotational dis-engagement of the key lock assembly thus allowing the key lock assembly to rotationally “free wheel” rotationally in relation to the bolt extension assembly and the thumb turn handle such that if excessive rotational force is applied to the key lock assembly to breach the dead bolt lock it would not matter toward breaching the dead bolt lock.

Further in the dead bolt lock prior art area in U.S. Pat. No. 1,125,791 to Aston, disclosed a bolt lock assembly that has the capacity to be freely rotated to thwart a thief from cutting the bolt as it will freely rotate, also the bolt lock is easily locked from the inside as against the operation of a regular key when applied from outside the door. Looking at FIG. 1, the bolt 4 reciprocates within housing 3 and terminates at 5 with an intermediate section of the bolt 4 being cutaway to provide the shaft 6 the plurality of annular teeth 7 that are on a rack bar and mesh with gear 8 that is on shaft 9 that extends inside through plates 10, 11 and interacts with hub 12, collar 13, and collar 15, with recess 16 that interacts with lug 17 on the inner side of extension 12. This results in extension 18 which enters slot opening 19 for rotational control of the tumblers in barrel 20, with extension 18 held by compression spring 23, wherein recess 16a on collar 15 the receives tooth 17, provides for pulling on knob 14 bringing the collar 15 into engagement with lug 17 by turning the knob 14 into notch 16 compressing spring 23 with extension 18 then being withdrawn from recess 19 thereby rotationally disengaging the key tumblers from the bolt 4, resulting in the key from outside not being able to unlock the lock via reciprocating the bolt 4, wherein the reciprocating bolt 4 is operable from inside via the rack bar and mesh with gear 8 that is on shaft 9 rotationally connected to knob 14.

In Aston '791 when the extension 18 is engaged in the recess 19 with the extension being taught in the form of a flat strip would be a poor design choice of material configuration as the extension 18 is subject to torque which when applied to a flat strip causes an uneven stress distribution that would be higher at the outer edges resulting is excessive deflection and a higher likelihood of permanent strain that could result in the flat strip 18 working its way out of the recess 19 causing the undesirable result of the lock not being openable from the outside key side. Further, Aston '791 utilizes the annular teeth 7 that are on a rack bar and mesh with gear 8 that is on shaft 9 to extend the bolt 4 that reciprocates the bolt 4 from turning knob 14 which is undesirable as this is a reversible process, i.e. if the bolt were pushed inward the knob 14 would rotate which is less secure that a toggle system that uses a linkage that locks the outward reciprocating movement of the bolt for greater security thus preventing the bolt from being pushed inward when extended.

What is needed is a lock out mechanism that safely selectively uses a security mechanism on the key lock assembly from the bolt extension assembly from the interior side of the door such that the application of significant rotational force against the exterior key lock assembly with or without the correct key by a criminal does not have the opportunity to cause damage to the dead bolt lock as the rotationally loose key lock assembly is simply rotationally “freewheeling” via not offering any rotational resistance for the criminal to apply a force toward, that can potentially cause an element to fail within the dead bolt lock assembly. In summarizing the above mentioned prior art in the current state of the art in deadbolt locks that have various security mechanisms, starting with Smith '199 whose patentability is in an inside pullout for the deadbolt extension lock—in Smith '343 whose patentability lays in a lockout mechanism (100) as an example to prevent accidental key disabling lockout, in Moore '169 whose patentability lays in having different locking options with a double ended key lock deadbolt lock assembly, in Garza whose patentability lays in the ability to activate (irreversibly) the key deactivation from the outside, in Moore '074 whose patentability is in retrofitting existing installed dead bolt locks, and in Aston '791 whose patentability is in using a sliding strip extension to removably engage the outside lock. So there are a number of differing approaches to adding dead bolt lock security with various advantages and disadvantages disclosed.

### SUMMARY OF INVENTION

Broadly, the present invention is a lock apparatus for selectively securing and unsecuring a first article to a second article, the lock apparatus comprises a first element including a primary end portion and an opposing secondary end portion with a longitudinal axis spanning therebetween, the first element having a first element rotational engagement about the longitudinal axis to the first article. Further included in the lock apparatus is an extension beam including a first end portion and an opposing second end portion with a lengthwise axis spanning therebetween, the extension beam having an extension beam rotational engagement about the lengthwise axis to the first article, wherein the lengthwise axis and the longitudinal axis are coincident to one another, wherein the extension beam second end portion has a structure to selectively rotationally engage and disengage the first element secondary end portion.

Also included in the lock apparatus is a means to selectively engage and disengage the second article that is driven from the extension beam, wherein operationally the extension beam selectively rotationally engages the first element and the extension beam selectively engages and disengages the first article to the second article, thus resulting in the extension beam always being able to selectively engage and disengage the first article to the second article and the first element only having an ability to selectively engage and disengage the first article to the second article when the first element and the extension beam are selectively rotationally engaged to one another.

These and other objects of the present invention will become more readily appreciated and understood from a consideration of the following detailed description of the exemplary embodiments of the present invention when taken together with the accompanying drawings, in which;

### BRIEF DESCRIPTION OF DRAWINGS

FIG. 1 shows an exploded perspective view of the lock apparatus minus the extension beam for pictorial clarity to easily show the lock cylinder with the primary and secondary end portions of the lock cylinder, plus the longitudinal axis of the lock cylinder, also the bolt extension assembly and the twist lock assembly with a lever are shown;

FIG. 2 shows an exploded perspective view of the lock apparatus that includes the extension beam with a lengthwise axis of the extension beam, the lock cylinder with the primary and secondary end portions of the lock cylinder, plus the longitudinal axis of the lock cylinder, also the bolt extension assembly and the twist lock assembly with a lever are shown;

FIG. 3 shows an exploded perspective view of the lock apparatus that includes the extension beam with the lengthwise axis of the extension beam, the lock cylinder with the primary and secondary end portions of the lock cylinder, plus the longitudinal axis of the lock cylinder, also the bolt extension assembly and the twist lock assembly with the lever are shown, wherein further included are the door and door with the lock cylinder and the twist lock assembly both rotationally engaged to the door plus the bolt extension assembly that selectively engages and disengages the door frame;

FIG. 4 shows a perspective view of the extension beam that includes the first and second end portion of the extension beam, the extension beam lengthwise axis, further the disc, key, L shaped key slot, and the pin is shown moving towards engaged rotational movement between the key slot and the outer sleeve sidewall (see FIGS. 4 and 5);

FIG. 5 shows a perspective view of the extension beam that includes the first and second end portion of the extension beam, the extension beam lengthwise axis, further the disc, key, L shaped key slot, and the pin is shown moving towards engaged rotational movement between the key slot and the outer sleeve sidewall (see FIGS. 4 and 5), also shown in an arced portion of the key slot, with the pin going toward the first or second axial position state;

FIG. 6 shows a perspective view of the structure to selectively rotationally engage and disengage the first element secondary end portion (not shown), the structure includes the conventional rotational engagement interface, the female annular portion, and the open slot receptacle;

FIG. 7 shows a reverse perspective view (from FIG. 6) of the structure to selectively rotationally engage and disengage the first element secondary end portion (not shown), the structure includes the conventional rotational engagement interface, the female annular portion, and the open slot receptacle;

FIG. 8 shows an opposing side perspective view of the structure to selectively rotationally engage and disengage the first element secondary end portion (not shown), the structure includes the conventional rotational engagement interface, the female annular portion, and the open slot receptacle;

FIG. 9 shows a perspective view of the structure to selectively rotationally engage and disengage the first element secondary end portion, the structure includes the conventional rotational engagement interface, the female annular portion, and the open slot receptacle, further FIG. 9 shows the second axial position state wherein the second end portion of the extension beam is rotationally disengaged from the structure and therefore rotationally disengaged from the first element and the lock cylinder;

FIG. 10 shows a perspective view of the structure to selectively rotationally engage and disengage the first element secondary end portion, the structure includes the conventional rotational engagement interface, the female annular portion, and the open slot receptacle, further FIG. 10 shows the first axial position state wherein the second end portion of the extension beam is rotationally engaged to the structure and therefore rotationally engaged to the first element and the lock cylinder;

FIG. 11 shows a side elevation view of the key hole ramp disc that includes the secondary side, part B of the second partial shoulder, and the key hole slot of the ramp disc;

FIG. 12 shows a perspective view of the key hole ramp disc that includes the first partial shoulder ridge, the lengthwise axis, the primary side of the disc, part A of the first partial shoulder ridge, and the key hole slot of the ramp disc;

FIG. 13 shows a side elevation view of the key hole ramp disc that includes the secondary side, part B of the second partial shoulder, and the key hole slot of the ramp disc, and the pin second portion superimposed for the first axial position state;

FIG. 14 shows a perspective view of the lever that includes the lengthwise axis, the first extension element, the outer sleeve sidewall, and the second portion of thee pin;

FIG. 15 shows a perspective view of the lever that includes the first extension element, the outer sleeve sidewall, and the first and second portions of the pin;

FIG. 16 shows a perspective view of the means for urging the first extension element or outer sleeve and the pin toward the key hole ramp disc toward one another, wherein the first extension element, outer sleeve, pin, and key hole ramp disc are not shown, wherein the means is preferably in the form of a spring;

FIG. 17 shows a perspective view of the lever, with the first extension element having a rotational engagement to the retainer about the lengthwise axis with rotational movement of the lever shown;

FIG. 18 shows a perspective assembly view of the second end portion of the extension beam, the spacer disc, the means to selectively engage or disengage the second article or bolt extension assembly, the means to removably lock the first axial position, the key hole ramp disc, and the lever, all with rotational movement about the lengthwise axis, all as shown in the second axial position state;

FIG. 19 shows a perspective assembly view of the second end portion of the extension beam, the spacer disc, the means to selectively engage or disengage the second article or bolt extension assembly, the means to removably lock the first axial position, the key hole ramp disc, and the lever, all with rotational movement about the lengthwise axis, all as shown in the second axial position state of the twist lock assembly; and

FIG. 20 shows a perspective assembly view of the second end portion of the extension beam, the spacer disc, the means to selectively engage or disengage the second article or bolt extension assembly, the means to removably lock the first axial position, the key hole ramp disc, and the lever, all with rotational movement about the lengthwise axis, all as shown in the first axial position state of the twist lock assembly.

### REFERENCE NUMBERS IN DRAWINGS

50 Lock Apparatus
55 Dead bolt lock apparatus
60 First article
65 Door
70 Second article
75 Door frame
80 First element
85 Lock cylinder
90 Primary end portion of the first element 80
95 Secondary end portion of the first element 80
100 Longitudinal axis of the first element 80
105 Rotational engagement about the longitudinal axis 100 of the first element 80 to the first article 60
110 Primary end portion of the lock cylinder 85
115 Secondary end portion of the lock cylinder 85
120 Longitudinal axis of the lock cylinder 85
125 Rotational engagement about the longitudinal axis 120 of the lock cylinder 85 to the door 65
130 Extension beam
135 First end portion of the extension beam 130
145 Second end portion of the extension beam 130
150 Lengthwise axis of the extension beam 130
155 Rotational engagement about the lengthwise axis 150 of the extension beam 130 to the first article 60 or door 65
160 Co-incident position of the lengthwise axis 150 to the longitudinal axis 100
165 Structure to selectively rotationally engage and disengage the first element 80 secondary end portion 95 or lock cylinder 85 secondary end portion 115
166 Conventional rotational engagement interface of the structure 165 to the first element 80 secondary end portion 95 about longitudinal axis 100
167 Conventional rotational engagement interface of the structure 165 to the lock cylinder 85 secondary end portion115 about longitudinal axis 100
170 Means to selectively engage and disengage the second article 70 that is driven from the extension beam 130
175 Bolt extension assembly to selectively engage and disengage the door frame 75 that is driven from the extension beam 130
180 Open slot receptacle of the structure 165
185 Female annular portion of the structure 165
190 Rotational engagement state of the key 415 and open slot receptacle 180 portion of the structure 165 facilitating rotational movement as between the extension beam 130 second end portion 145 to the first element 80 secondary end portion 95
195 Rotational engagement state of the key 415 and open slot receptacle 180 portion of the structure 165 facilitating rotational movement as between the extension beam 130 second end portion 145 to the lock cylinder 85 secondary end portion 115
200 Means for urging the key 415 into the open slot receptacle 180 or disc 410 apart from the annular portion 185 along the longitudinal axis 150 to engage the rotational engagement state 190 of the extension beam 130 second end portion 145 to the first element 80 secondary end portion 95
205 Means for urging the key 415 into the open slot receptacle 180 or disc 410 apart from the annular portion 185 along the longitudinal axis 150 to engage the rotational engagement state 190 of the extension beam 130 second end portion 145 to the lock cylinder 85 secondary end portion 115
210 Default bias movement of the means 200 for urging toward the extension beam 130 second
end portion 145 and apart from the first element 80 secondary end portion 95 being rotationally engaged in a rotationally engaged state 250 in a first axial position from the means 200 for urging
215 Default bias movement of the means 205 for urging toward the extension beam 130 second end portion 145 and apart from the lock cylinder 85 secondary end portion 115 being rotationally engaged in the rotationally engaged state 250 in the first axial position from the means 205 for urging
216 Means for urging the key 415 into the open slot receptacle 180 or disc 410 apart from the annular portion 185 along the longitudinal axis 150 shown compressed to disengage the rotational engagement state 190 of the extension beam 130 second end portion 145 to the first element 80 secondary end portion 95
217 Means for urging the key 415 into the open slot receptacle 180 or disc 410 apart from the annular portion 185 along the longitudinal axis 150 shown compressed to disengage the rotational engagement state 190 of the extension beam 130 second end portion 145 to the lock cylinder 85 secondary end portion 115
218 Default bias opposing movement of the means 200 for overcoming the urging toward the extension beam 130 second end portion 145 and apart from the first element 80 secondary end portion 95 to compress the means 200 thus being rotationally disengaged in a second axial position state 255 as between the extension beam 130 second end portion 145 and the first element 80 secondary end portion 95
219 Default bias opposing movement of the means 205 for urging toward the extension beam 130 second end portion 145 and apart from the lock cylinder 85 secondary end portion 115 to compress the means 205 to being rotationally disengaged in the in the second axial position state 255 as between the extension beam 130 second end portion 145 and the lock cylinder 85 secondary end portion 115
220 Spring for the means 200, 205 for urging the key 415 into the open slot receptacle 180 or disc 410 apart from the annular portion 185 along the longitudinal axis 150 forming the rotationally engaged state 250 in the first axial position
225 Twist lock assembly
230 Rotational engagement of the twist lock assembly 225 to the first article 60
235 Rotational engagement of the twist lock assembly 225 to the door 65
240 Rotational engagement of the twist lock assembly 225 to the extension beam 130 first end portion 135
245 Rotational movement of the twist lock assembly 225 about the lengthwise axis 150
250 First axial position state of the twist lock assembly 225 wherein the extension beam 130 and the first element 80 are rotationally engaged to one another about the lengthwise axis 150
255 Second axial position state of the twist lock assembly 225 wherein the extension beam 130 and the first element 80 are rotationally disengaged from one another about the lengthwise axis 150
260 Means to removably lock the first axial position 250
265 Fixed amount of rotation about the lengthwise axis 150 to unlock the twist lock assembly 225 from the first axial position state 250 to the second axial position state 255
270 First extension element
285 Retainer
286 Key hole ramp disc
287 Key hole slot of the ramp disc 286
288 First partial shoulder ridge of the key hole slot 287
289 Primary side of the disc 286
290 Rotational engagement of the retainer 285 to the first 270 extension element
291 Second partial shoulder of the key hole slot 287
292 Secondary side of the key hole ramp disc 286
293 Part A of the first partial shoulder ridge 288
294 Part B of the first partial shoulder ridge 288
295 Affixed position of the retainer 285 to the first article 60
300 Affixed position of the retainer 285 to the door 65
305 Interlock axially of the first extension element 270 and the retainer 285 and key hole ramp disc 286 forming the first axial position 250
315 Engaged rotational movement about the lengthwise axis 150 as between the first 270 extension element and L shaped key slot 405
330 Outer sleeve sidewall
340 Engaged rotational movement as between the L shaped key slot 405 and outer sleeve sidewall 330
350 Lever type manual grasping point for the inner sleeve 325
355 Turning the lever 350 manually about the lengthwise axis 150 that turns the extension beam
130 that subsequently causes the bolt extension assembly 175 to engage the door frame 75 thus operationally securing the door 65 to the door frame 75 in the first axial position state 250
365 Pushing and turning manually the lever 350 along the lengthwise axis 150 toward the lock cylinder 85 to disengage the open slot receptacle 180 and female annular portion 185 thus taking the outer sleeve 330 from the first axial position state 250 to the second axial position state 255 with an additional manual turn of the lever 350 thus rotationally having the lock cylinder 85 disengaged from the extension beam 130 that is engaged to the bolt extension assembly 175
400 Pin of the first extension element 270, outer sleeve 330
405 L shaped key slot of the extension beam 130
410 Disc of the extension beam 130
415 Key of the extension beam 130
420 Spacer disc
425 First portion of the pin 400
426 Second portion of the pin 400
430 Straight portion of the key slot 405
435 Arced portion of the key slot 405
440 Means for urging first extension element 270 or outer sleeve 330 and the pin 400 toward the key hole ramp disc 286 toward one another
445 Means 440 in the form of a spring
450 Pilot retainer guide between spring 445 and the first extension element 270 or outer sleeve 330

### DETAILED DESCRIPTION

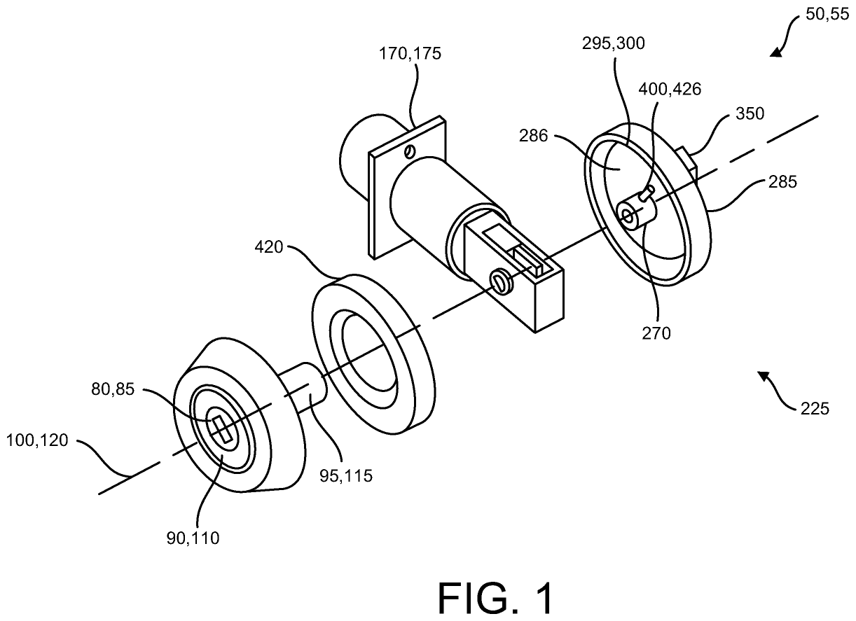

With initial reference to FIG. 1 shown is an exploded perspective view of the lock apparatus 50, 55 minus the extension beam 130 for pictorial clarity to easily show the lock cylinder 85 with the primary 90 and secondary 95 end portions of the lock cylinder 85, the spacer disc 420, plus the longitudinal axis 120 of the lock cylinder 85, also the bolt extension assembly 175 and the twist lock assembly 225 with a lever 350 are shown, further shown is the key hole ramp disc 286, the first extension element 270, the retainer 285, and the second portion 426 of the pin 400.

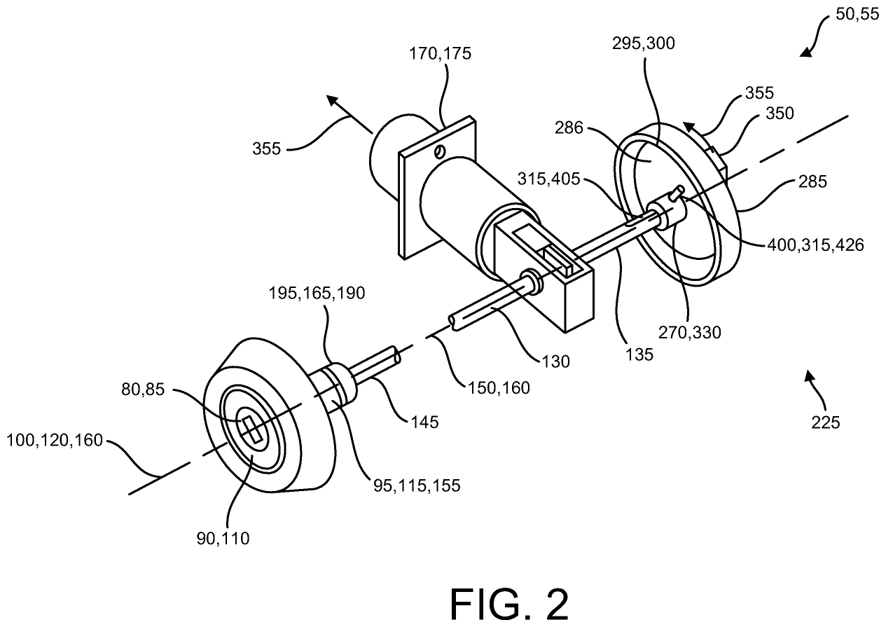

Continuing, FIG. 2 shows an exploded perspective view of the lock apparatus 50, 55 that includes the extension beam 130 with a lengthwise axis 150 of the extension beam 130, the lock cylinder 85 with the primary 90 and secondary 95 end portions of the lock cylinder 85, plus the longitudinal axis 120 of the lock cylinder 85, also the bolt extension assembly 175 and the twist lock assembly 225 with a lever 350 are shown, further shown is the first end portion 135 of the extension beam 130 that has the L shaped key slot 405, also shown is the key hole ramp disc 286, the first extension element 270, the retainer 285, and the second portion 426 of the pin 400, in addition to turning rotational movement 355 of the lever 350.

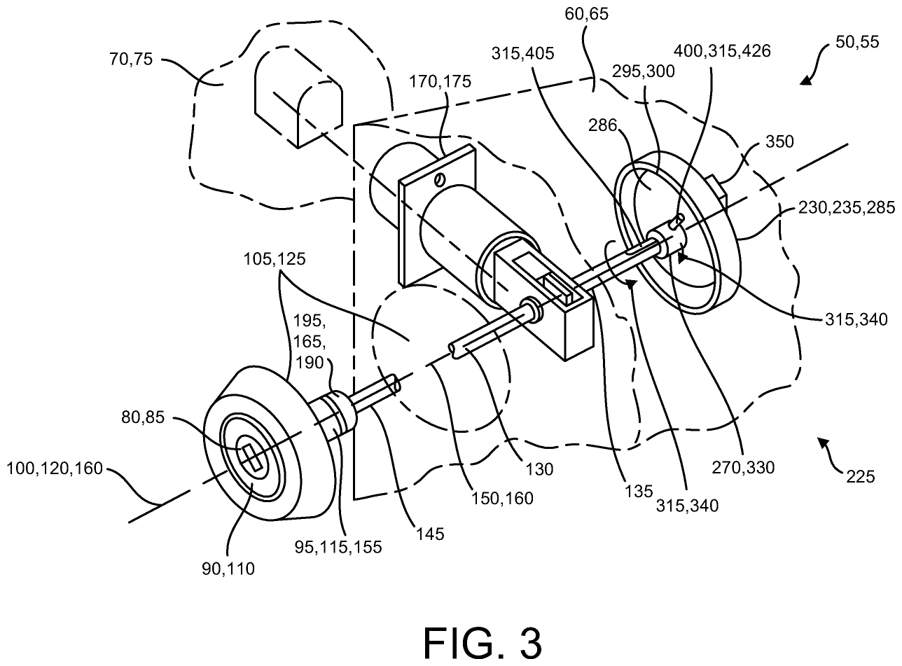

Next, FIG. 3 shows an exploded perspective view of the lock apparatus 50, 55 that includes the extension beam 130 with the lengthwise axis 150 of the extension beam 130, the lock cylinder 85 with the primary 90 and secondary 95 end portions of the lock cylinder 85, plus the longitudinal axis 120 of the lock cylinder 85, also the bolt extension assembly 175 and the twist lock assembly 225 with the lever 350 are shown. Further FIG. 3 shows the door 60, 65 and door 60, 65 with the lock cylinder 85 and the twist lock assembly 225 both rotationally engaged 125, 235 to the door 60, 65 plus the bolt extension assembly 175 that selectively 355 engages and disengages the door frame 70, 75, further shown is the first end portion 135 of the extension beam 130 that has the L shaped key slot 405, also shown is the key hole ramp disc 286, the first extension element 270, the retainer 285, and the second portion 426 of the pin 400.

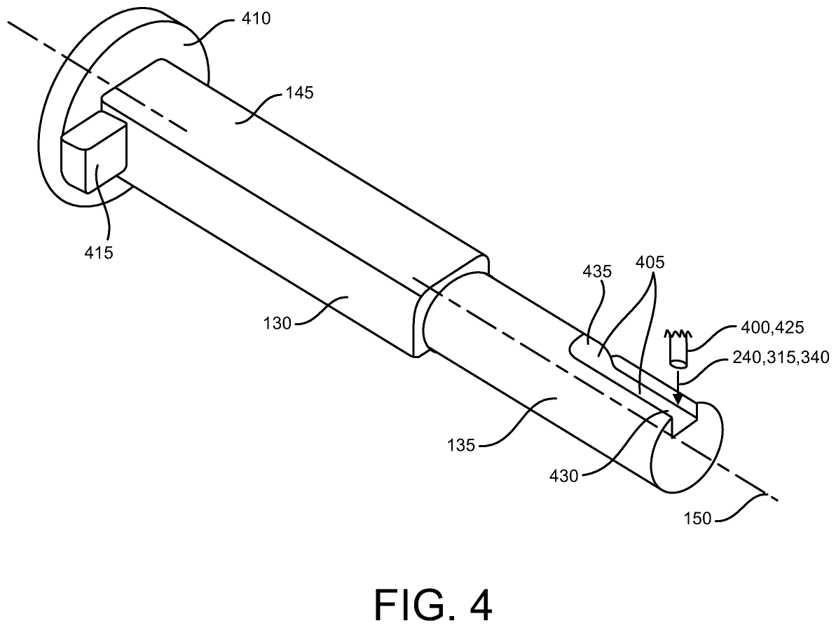

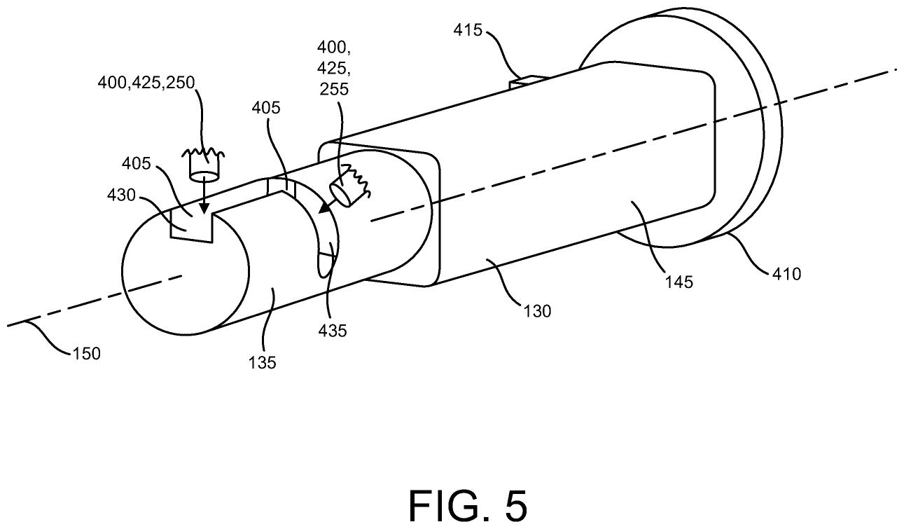

Moving onward, FIG. 4 shows a perspective view of the extension beam 130 that includes the first 135 and second 145 end portions of the extension beam 130, the extension beam 130 lengthwise axis 150, further the disc 410, key 415, L shaped key slot 405, and the pin 400 is shown moving towards 240, 315, 340 engaged rotational movement between the key slot 405 and the outer sleeve sidewall 330 (also see FIGS. 5, 14, and 15).

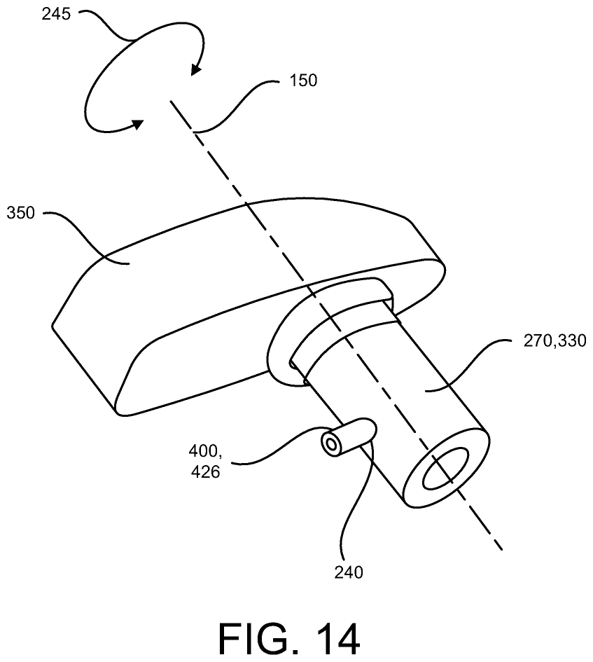

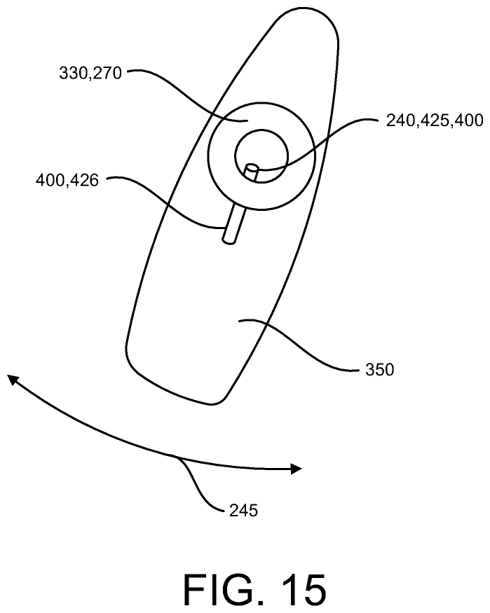

Continuing, FIG. 5 shows a perspective view of the extension beam 130 that includes the first 135 and second 145 end portions of the extension beam 130, the extension beam 130 lengthwise axis 150, further the disc 410, key 415, L shaped key slot 405, and the first portion 425 of the pin 400 is shown moving towards 250 engaged rotational movement between the key slot 405 and the outer sleeve sidewall 330 (see FIGS. 14 and 15), also shown in an arced portion 435 of the key slot 405 and the straight portion 430 of the key slot 405, with the first portion 425 of the pin 400 also going toward the first 250 or second 255 axial position state.

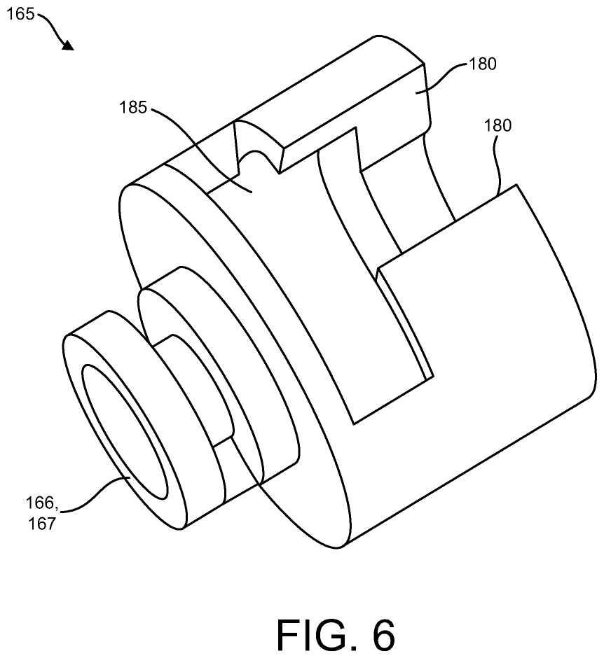

Moving ahead, FIG. 6 shows a perspective view of the structure 165 to selectively rotationally engage and disengage the first element 80 secondary end portion 95 (not shown), the structure 165 includes the conventional rotational engagement interface 166, 167, the female annular portion 185, and the open slot receptacle 180.

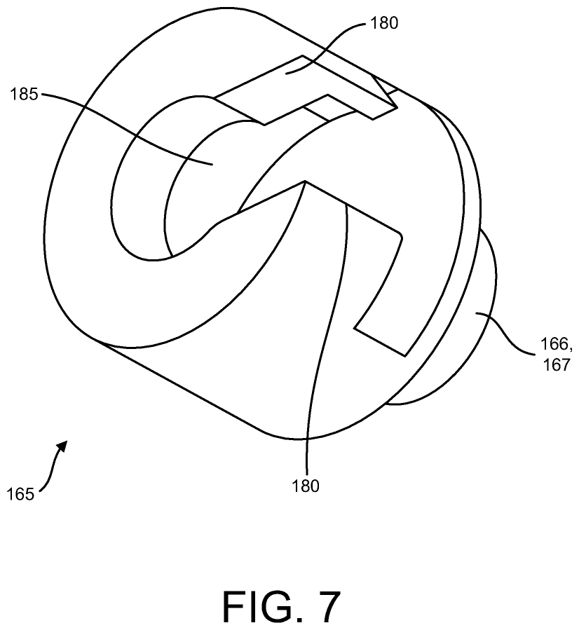

Next, FIG. 7 shows a reverse perspective view (from FIG. 6) of the structure 165 to selectively rotationally engage and disengage the first element 80 secondary end portion 95 (not shown), the structure 165 includes the conventional rotational engagement interface 166, 167, the female annular portion 185, and the open slot receptacle 180.

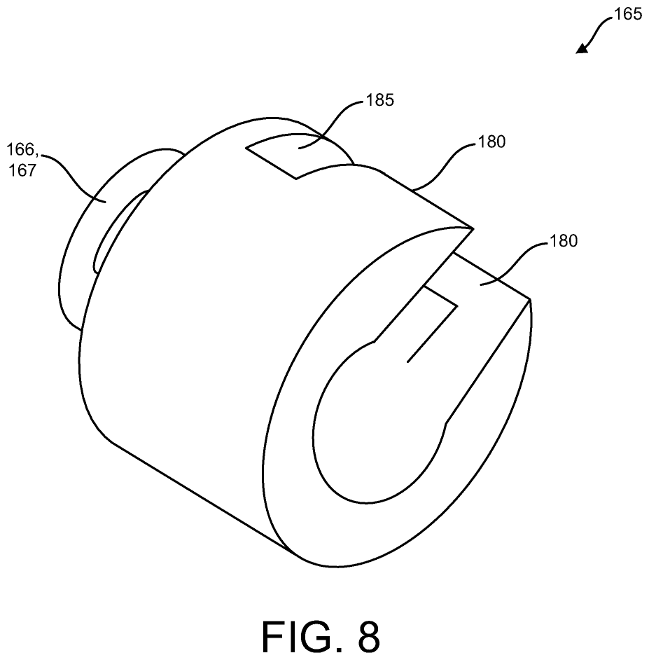

Further, FIG. 8 shows an opposing side perspective view of the structure 165 to selectively rotationally engage and disengage the first element 80 secondary end portion 95 (not shown), the structure 165 includes the conventional rotational engagement interface 166, 167, the female annular portion 185, and the open slot receptacle 180.

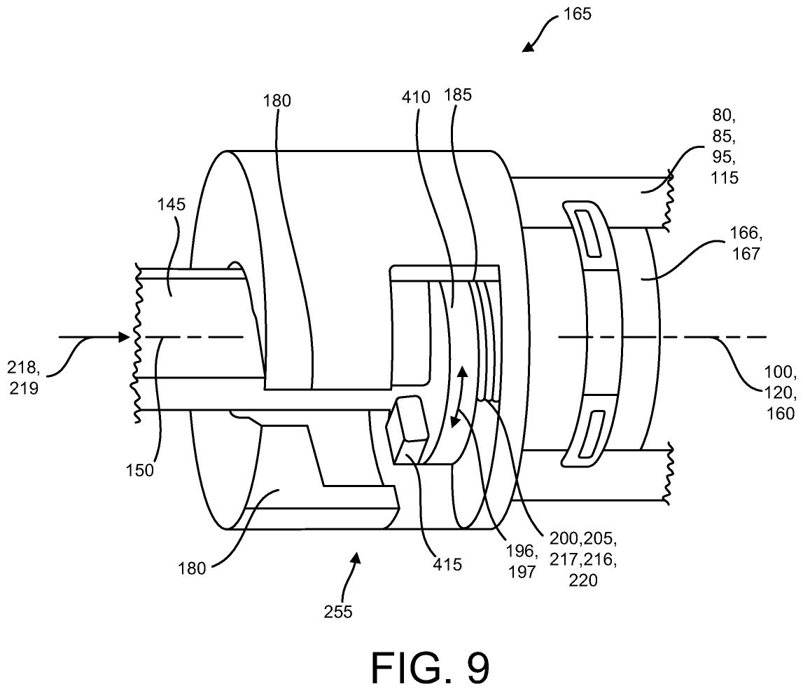

Continuing, FIG. 9 shows a perspective view of the structure 165 to selectively rotationally engage and disengage the first element 80 secondary end portion 95, the structure 165 includes the conventional rotational engagement interface 166, 167, the female annular portion 185, and the open slot receptacle 180, further FIG. 9 shows the second axial position state 255 wherein the second end portion 145 of the extension beam 130 is rotationally disengaged from the structure 165 and therefore rotationally disengaged from the first element 80 and the lock cylinder 85.

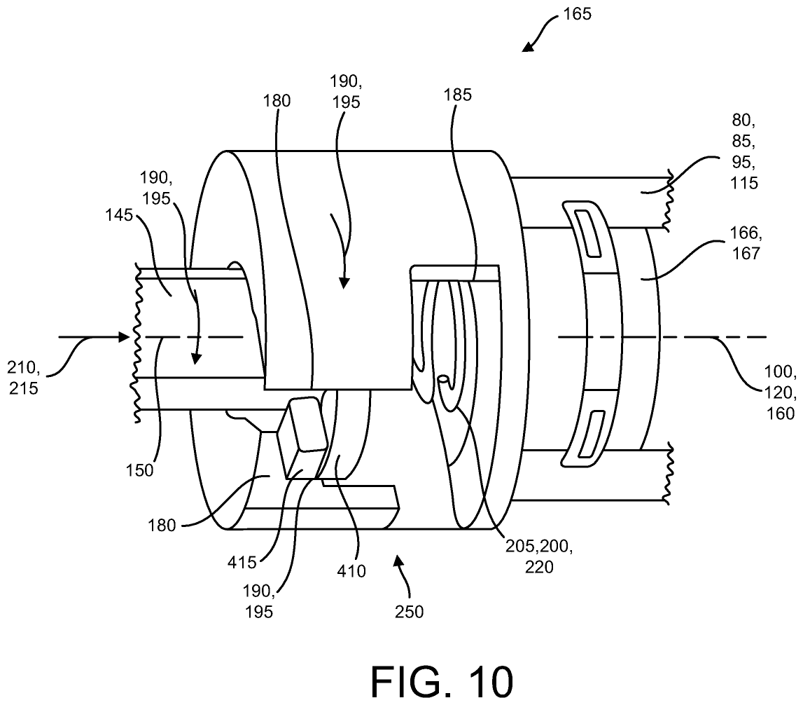

Further, FIG. 10 shows a perspective view of the structure 165 to selectively rotationally engage and disengage the first element 80 secondary end portion 95, the structure 165 includes the conventional rotational engagement interface 166, 167, the female annular portion 185, and the open slot receptacle 180, further FIG. 10 shows the first axial position state 250 wherein the second end portion 145 of the extension beam 130 is rotationally engaged to the structure 165 and therefore rotationally engaged to the first element 80 and the lock cylinder 85.

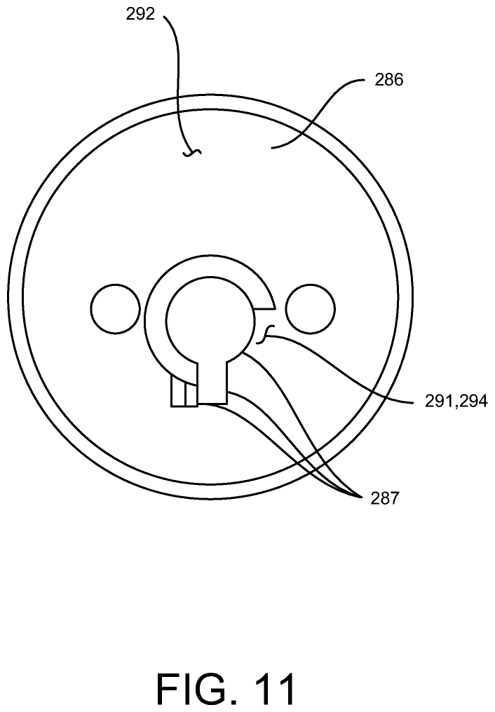

Moving onward, FIG. 11 shows a side elevation view of the key hole ramp disc 286 that includes the secondary side 292, part B 294 of the second partial shoulder 291, and the key hole slot 287 of the ramp disc 286.

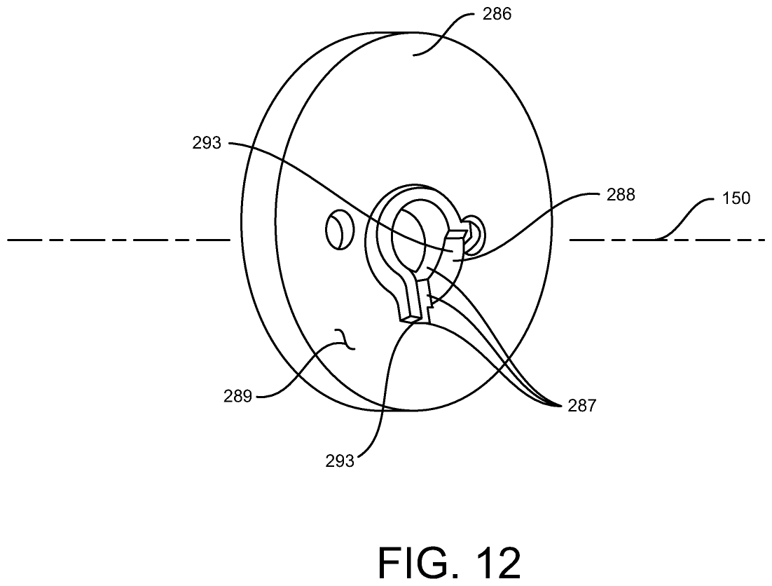

Next, FIG. 12 shows a perspective view of the key hole ramp disc 286 that includes the first partial shoulder ridge 288, the lengthwise axis 150, the primary side 289 of the disc 286, part A 293 of the first partial shoulder ridge 288, and the key hole slot 287 of the ramp disc 286.

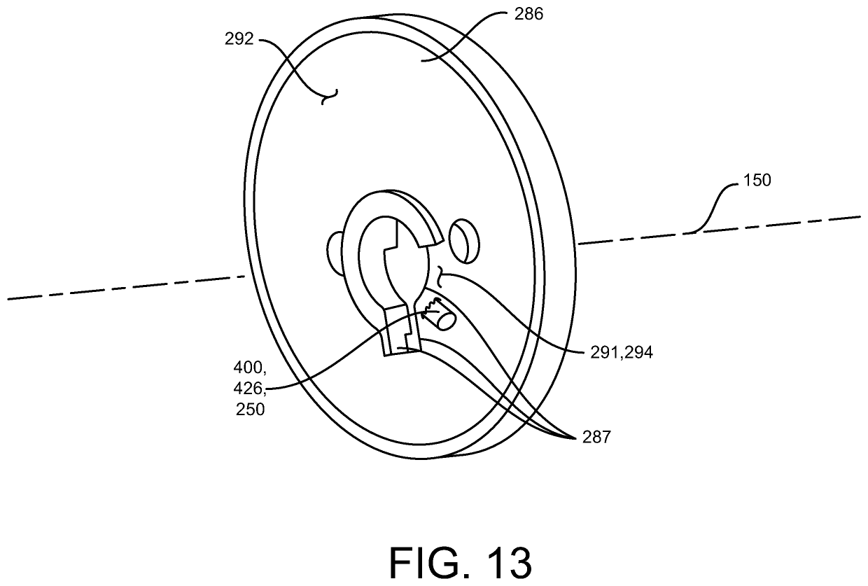

Further, FIG. 13 shows a side elevation view of the key hole ramp disc 286 that includes the secondary side 292, part B 294 of the second partial shoulder 291, and the key hole slot 287 of the ramp disc 286, and the pin 400 second portion 426 superimposed for the first axial position state 250.

Continuing, FIG. 14 shows a perspective view of the lever 350 that includes the lengthwise axis 150, the first extension element 270, the outer sleeve sidewall 330, and the second portion 426 of the pin 400.

Next, FIG. 15 shows a perspective view of the lever 350 that includes the first extension element 270, the outer sleeve sidewall 330, and the first 425 and second 426 portions of the pin 400.

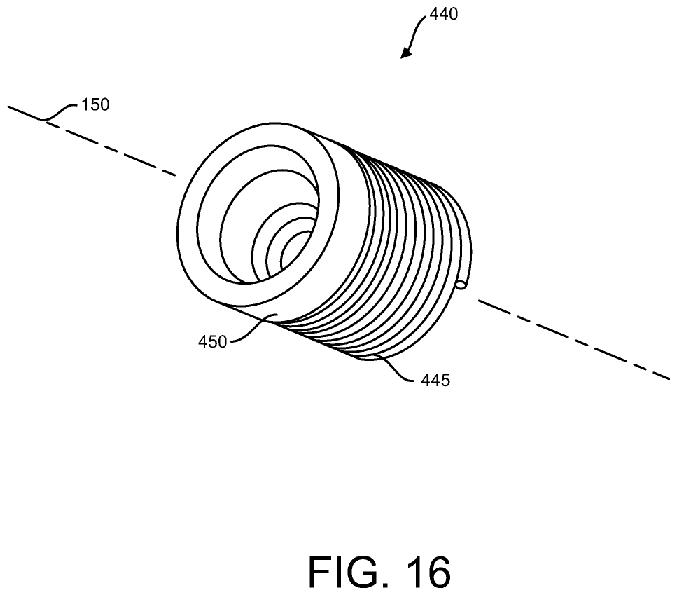

Continuing, FIG. 16 shows a perspective view of the means for urging 440 the first extension element 270 or outer sleeve 330 and the pin 400 toward the key hole ramp disc 286 toward one another, wherein the first extension element 270, outer sleeve 330, pin 400, and key hole ramp disc 286 are not shown, wherein the means 440 is preferably in the form of a spring 445.

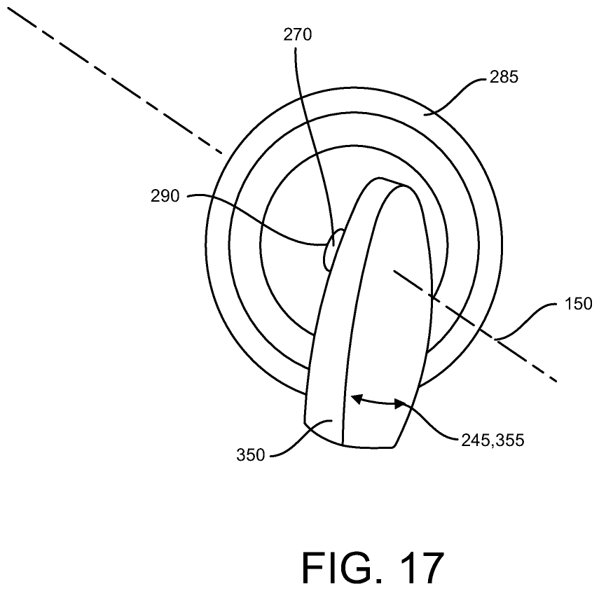

Next, FIG. 17 shows a perspective view of the lever 350, with the first extension element 270 having a rotational engagement to the retainer 285 about the lengthwise axis 150 with rotational movement 245, 355 of the lever 350 shown.

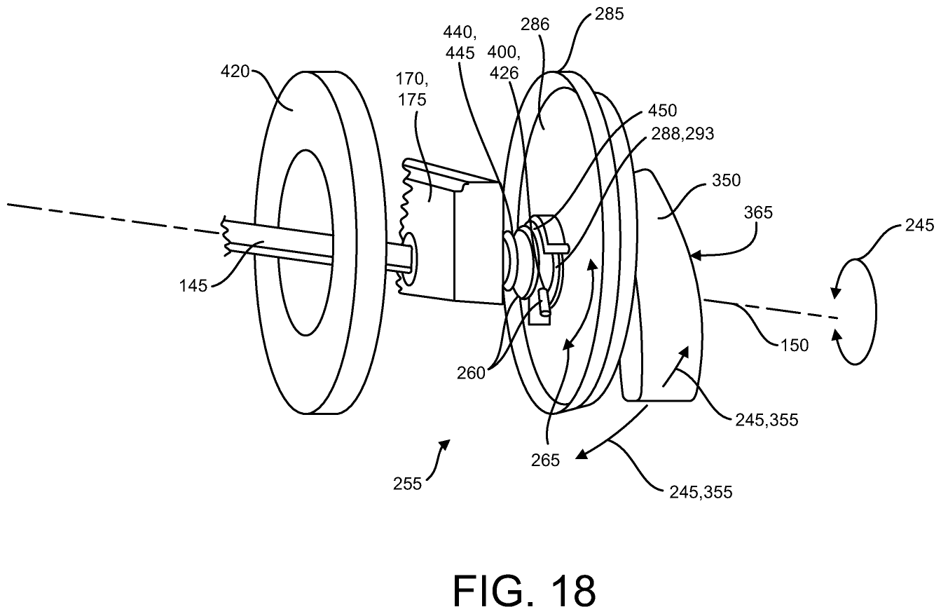

Further, FIG. 18 shows a perspective assembly view of the second end portion 145 of the extension beam 130, the spacer disc 420, the means 170 to selectively engage or disengage the second article 70, 75 or bolt extension assembly 175, the means 260 to removably lock the first axial position 250, the key hole ramp disc 286, and the lever 350 all with rotational movement 245 about the lengthwise axis 150, all as shown in the second axial position state 255 of the twist lock assembly 225.

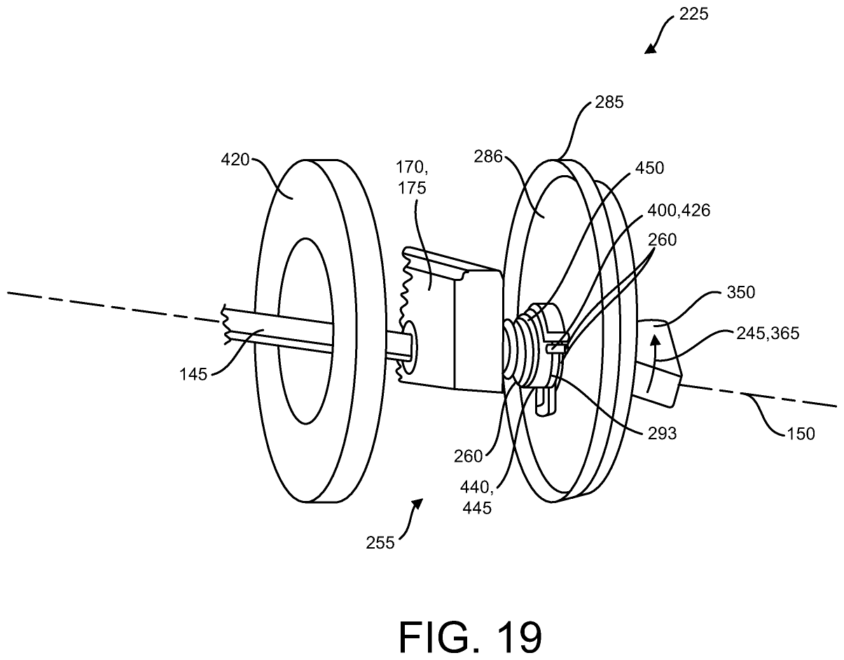

Next, FIG. 19 shows a perspective assembly view of the second end portion 145 of the extension beam 130, the spacer disc 420, the means 170 to selectively engage or disengage the second article 70, 75 or bolt extension assembly 175, the means 260 to removably lock the first axial position 250, the key hole ramp disc 286, and the lever 350 all with changed rotational movement 245, 365 about the lengthwise axis 150, all as shown in the second axial position state 255 of the twist lock assembly 225.

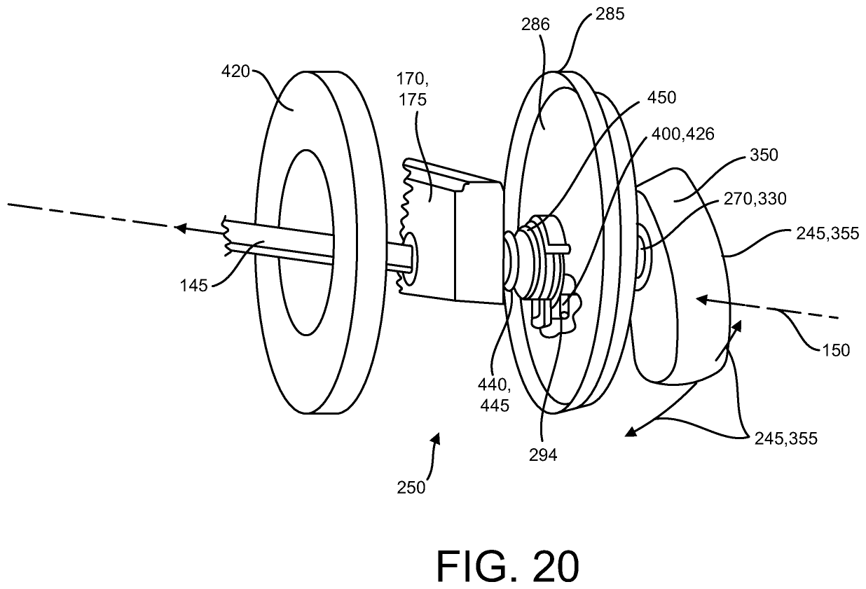

Further, FIG. 20 shows a perspective assembly view of the second end portion 145 of the extension beam 130, the spacer disc 420, the means 170 to selectively engage or disengage the second article 70, 75 or bolt extension assembly 175, the means 260 to removably lock the first axial position 250, the key hole ramp disc 286, and the lever 350 all with rotational movement 245, 355 about the lengthwise axis 150, all as shown in the first axial position state 250 of the twist lock assembly 225.

Broadly, in referring to FIGS. 1 to 20, the present invention is of the lock apparatus 50, 55 for selectively securing and un-securing the first article 60 to the second article 70, the lock apparatus 50, 55 comprises the first element 80 including the primary end portion 90 and the opposing secondary end portion 95 with the longitudinal axis 100 spanning therebetween, the first element 80 having a first element 80 rotational engagement 105 about the longitudinal axis 100 that is adapted to attach to the first article 60, see FIGS. 1, 2, and 3. Further included in the lock apparatus 50, 55 is the extension beam 130 including the first end portion 135 and the opposing second end portion 145 with the lengthwise axis 150 spanning therebetween, the extension beam 130 having the extension beam 130 rotational engagement 155 about the lengthwise axis 150 that is adapted to attach to the first article 60, wherein the lengthwise axis 150 and the longitudinal axis 100 are coincident 160 to one another, see FIG. 3 in particular and also FIG. 2. Wherein the extension beam 130 second end portion 145 has structure 165 to selectively rotationally engage and disengage the first element 80 secondary end portion 95, see FIGS. 2 to 10 and FIGS. 18 to 20.

Also included in the lock apparatus 50, 55 is the means 170 to selectively engage and disengage the second article 70 that is driven from the extension beam 130, wherein operationally the extension beam 130 selectively rotationally engages the first element 80 via the structure 165 and the extension beam 130 selectively engages and disengages the first article 60 to the second article 70, thus resulting in the extension beam 130 always being able to selectively engage and disengage the first article 60 to the second article 70 and the first element 80 only having an ability to selectively engage and disengage the first article 60 to the second article 70 when the first element 80 and the extension beam 130 are selectively rotationally engaged 190 to one another via the structure 165, see in particular FIGS. 2, 3, 9, and 10 in particular, plus FIGS. 18 to 20.

An option for the lock apparatus 50, 55 wherein the structure 165 is constructed of an open slot receptacle 180 that is received in a female annular portion 185 that includes the means for urging 200 the open slot receptacle 180 and the female annular portions 185 apart from one another to operationally cause a default bias toward the extension beam 130 second end portion 145 and the first element 80 secondary end portion 95 being rotationally engaged or in the first axial position state 250, see FIG. 10, wherein manual effort is required to overcome the default bias to rotationally disengage the extension beam 130 second end portion 145 and the first element 80 secondary end portion 95 thus creating the second axial position state 255, see FIG. 9.

Alternatively, for the lock apparatus 50, 55, a key can preferably be disposed 405 on the extension beam 130 second end portion 145 and the open slot receptacle 180 and female annular portion 185 is disposed on the is preferably disposed on the first element 80 secondary end portion 95, as best shown in FIGS. 4 to 8 in particular and also assembled in FIGS. 9 and 10.

Further, optionally for the lock apparatus 50, 55 the means for urging 200 is preferably constructed of a spring 220 that is disposed within the female annular portion 185 to operationally have the urging movement 210 along the longitudinal axis 120, see in particular FIGS. 9 and 10, plus FIG. 16.

Another alternative for the lock apparatus 50, 55 can further comprise a twist lock assembly 225 that is adapted to be rotationally engaged 230 to the first article 60, the twist lock assembly 225 is rotationally engaged 240 to the extension beam 130 first end portion 135, the twist lock assembly 225 having rotational movement 245 about the lengthwise axis 150, the twist lock assembly 225 also having a means 260 to removably lock the first axial position state 250 along the lengthwise axis 150 and use a fixed amount of rotation 265 about the lengthwise axis 150 to unlock the first axial position state 250 to the second axial position state 255 along the lengthwise axis 150, see FIGS. 18, 19, and 20, plus FIGS. 9 and 10. Wherein operationally the twist lock assembly 225 facilitates the structure 165 to rotationally engage the first element 80 secondary end portion 95 and the extension beam 130 second end portion 145 to one another in the first axial position state 250 and to disengage the rotational engagement state 190 at the first element 80 secondary end portion 95 and the extension beam 130 second end portion 145 when in the second axial position state 255, see FIGS. 9 and 10 in particular.

As a continuing alternative for the lock apparatus 50, 55 wherein the twist lock assembly 225 further comprises the first extension element 270 that is parallel to the lengthwise axis 150 and a retainer 285 that is rotationally engaged to the first extension element 270 that is adapted to be affixed to the first article 60, wherein the first extension element 270 selectively axially interlocks with a key hole ramp disc 286 disposed within the retainer 285 to form the first axial position state 250, see FIG. 10, and the first extension element 270 selectively locks with the retainer 285 and key hole ramp disc 286 to form the second axial position state 255, see FIG. 9. Wherein the first 270 extension element and the extension beam 130 first end portion 135 are axially affixed to one another along the lengthwise axis 150 via an axial interface in said second axial position state 255, wherein first 270 extension element is rotationally engaged to the extension beam 130 first end portion 135, see FIG. 10. This is to operationally allow selective rotational engagement 250 and disengagement 255 as between the first extension element 270 and the first element 80 secondary end portion 95 allowing independent engagement 190 of the means 170 to selectively engage and disengage the second article 70 via the first extension element 270, see FIGS. 2 and 3, plus FIGS. 10 and 20.

As a further alternative for the lock apparatus 50, 55 wherein the first 270 extension element is preferably respectively constructed of an outer 330 sleeve, the extension beam 130 first end portion 135 is partially disposed within the outer sleeve 330, wherein the first extension element 270 is the outer sleeve 330 and the extension beam 130 first end portion 135 and the outer sleeve 330 are axially and rotationally connected through the “L” shaped key slot 405 disposed on a portion of extension beam 130 first end portion 135, see FIGS. 4 and 5. Further, a pin 400 is disposed therethrough a sidewall of the outer sleeve 330, see FIGS. 14 and 15, wherein a first portion 425 of the pin 400 engages the “L” shaped key slot 405, again see FIGS. 4 and 5, that operationally rotationally and axially connects the outer sleeve 330 and the extension beam 130 about the lengthwise axis 150 in the second axial position state 255 with the pin 400 first portion 425 in an arched portion 435 of the “L” shaped key slot 405 in the first axial position state 250 with the pin 400 first portion 425 in a straight portion 430 of the “L” shaped key slot 405 of the extension beam 130 first end portion 135, see FIGS. 4 and 5.

As a continuing alternative for the lock apparatus 50, 55, wherein the outer sleeve 330 can further comprises a thumb lever 350 type manual grabbing point, see FIGS. 14 and 15, plus FIGS. 18 to 20.

As a further continuing alternative for the lock apparatus 50, 55, in referring to primarily to FIGS. 11 to 13, and secondarily to FIGS. 14 to 20, wherein the retainer 285 is preferably constructed of the key hole ramp disc 286 that includes the keyhole type slot 287 disposed therethrough the key hole ramp disc 286 wherein the keyhole type slot 287 has the first partial shoulder ridge 288 disposed on the primary side 289 of the disc 286 and the second partial shoulder ridge 291 disposed on the secondary side 292 of the disc 286 wherein the first 288 and second 291 partial shoulder ridges are positioned in an opposing manner to one another about the keyhole type slot 287, wherein operationally the second portion 426 of the pin 400 passes therethrough the keyhole type slot 287 being rotated such that the second portion 426 of the pin 400 is to be slidably engaged to a part A 293 of the first partial shoulder ridge 288 in the second axial position state 255 and the second portion 426 of the pin 400 is slidably engaged to a part B 294 of the first partial shoulder ridge 288 in the first axial position state 250, also see FIGS. 9 and 10.

Again broadly looking at FIGS. 1 to 20 for the dead bolt lock apparatus 55 for selectively securing and un-securing the door 65 to the door frame 75, the lock apparatus 55 comprises the lock cylinder 85 including the primary end portion 110 and the opposing secondary end portion 115 with the longitudinal axis 120 spanning therebetween, the lock cylinder 85 having a rotational engagement 125 about the longitudinal axis 120 that is adapted to attach to the door 65, as best shown in FIG. 3.

Further included in the dead bolt apparatus 55 is the extension beam 130 including the first end portion 135 and the opposing second end portion 145 with the lengthwise axis 150 spanning therebetween, the extension beam 130 having the extension beam 130 rotational engagement about the lengthwise axis 150 to the lock cylinder 85, wherein the lengthwise axis 150 and the longitudinal axis 100 are coincident 160 to one another, wherein the extension beam 130 second end portion 145 has structure 165 to selectively rotationally engage and disengage the lock cylinder 85 secondary end portion 115, as best shown in FIGS. 2 to 10 and FIGS. 18 to 20.

Also included in the dead bolt apparatus 55 is the bolt extension assembly 175 to selectively engage and disengage the door frame 75 that is driven from the extension beam 130, wherein operationally the extension beam 130 selectively rotationally engages 165 the lock cylinder 85 and the extension beam 130 selectively 175 engages and disengages the door 65 to the door frame 75, thus resulting in the extension beam 130 always being able to selectively 175 engage and disengage the door 65 to the door frame 75 and the lock cylinder 85 only having an ability to selectively engage and disengage the door 65 to the door frame 75 when the lock cylinder 85 and the extension beam 130 are selectively rotationally engaged 195 to one another, see in particular FIGS. 2, 3, 9, and 10 in particular, plus FIGS. 18 to 20.

An option for the lock apparatus 50, 55 wherein the structure 165 is constructed of an open slot receptacle 180 that is received in a female annular portion 185 that includes the means for urging 200 the open slot receptacle 180 and the female annular portions 185 apart from one another to operationally cause a default bias toward the extension beam 130 second end portion 145 and the lock cylinder 85 secondary end portion 115 being rotationally engaged or in the first axial position state 250, see FIG. 10, wherein manual effort is required to overcome the default bias to rotationally disengage the extension beam 130 second end portion 145 and the lock cylinder 85 secondary end portion 115 thus creating the second axial position state 255, see FIG. 9.

Alternatively, for the lock apparatus 50, 55, a key can preferably be disposed 405 on the extension beam 130 second end portion 145 and the open slot receptacle 180 and female annular portion 185 is disposed on the is preferably disposed on the lock cylinder 85 secondary end portion 115, as best shown in FIGS. 4 to 8 in particular and also assembled in FIGS. 9 and 10.

Further, optionally for the lock apparatus 50, 55 the means for urging 200 is preferably constructed of a spring 220 that is disposed within the female annular portion 185 to operationally have the urging movement 210 along the longitudinal axis 120, see in particular FIGS. 9 and 10, plus FIG. 16.

Another alternative for the lock apparatus 50, 55 can further comprise a twist lock assembly 225 that is adapted to be rotationally engaged 230 to the door 65, the twist lock assembly 225 is rotationally engaged 240 to the extension beam 130 first end portion 135, the twist lock assembly 225 having rotational movement 245 about the lengthwise axis 150, the twist lock assembly 225 also having a means 260 to removably lock the first axial position state 250 along the lengthwise axis 150 and use a fixed amount of rotation 265 about the lengthwise axis 150 to unlock the first axial position state 250 to the second axial position state 255 along the lengthwise axis 150, see FIGS. 18, 19, and 20, plus FIGS. 9 and 10. Wherein operationally the twist lock assembly 225 facilitates the structure 165 to rotationally engage the first lock cylinder 85 secondary end portion 115 and the extension beam 130 second end portion 145 to one another in the first axial position state 250 and to disengage the rotational engagement state 190 at the lock cylinder 85 secondary end portion 115 and the extension beam 130 second end portion 145 when in the second axial position state 255, see FIGS. 9 and 10 in particular.

As a continuing alternative for the lock apparatus 50, 55 wherein the twist lock assembly 225 further comprises the first extension element 270 that is parallel to the lengthwise axis 150 and a retainer 285 that is rotationally engaged to the first extension element 270 that is adapted to be affixed to the door 65, wherein the first extension element 270 selectively axially interlocks with a key hole ramp disc 286 disposed within the retainer 285 to form the first axial position state 250, see FIG. 10, and the first extension element 270 selectively locks with the retainer 285 and key hole ramp disc 286 to form the second axial position state 255, see FIG. 9.

Wherein the first 270 extension element and the extension beam 130 first end portion 135 are axially affixed to one another along the lengthwise axis 150 via an axial interface in said second axial position state 255, wherein first 270 extension element is rotationally engaged to the extension beam 130 first end portion 135, see FIG. 10. This is to operationally allow selective rotational engagement 250 and disengagement 255 as between the first extension element 270 and the lock cylinder 85 secondary end portion 115 allowing independent engagement 190 of the bolt extension assembly 175 to selectively engage and disengage the door frame 75 via the first extension element 270, see FIGS. 2 and 3, plus FIGS. 10 and 20.

As a further alternative for the lock apparatus 50, 55 wherein the first 270 extension element is preferably respectively constructed of an outer 330 sleeve, the extension beam 130 first end portion 135 is partially disposed within the outer sleeve 330, wherein the first extension element 270 is the outer sleeve 330 and the extension beam 130 first end portion 135 and the outer sleeve 330 are axially and rotationally connected through the “L” shaped key slot 405 disposed on a portion of extension beam 130 first end portion 135, see FIGS. 4 and 5, and a pin 400 disposed therethrough a sidewall of the outer sleeve 330, see FIGS. 14 and 15, wherein a first portion 425 of the pin 400 engages the “L” shaped key slot 405, again see FIGS. 4 and 5, that operationally rotationally and axially connects the outer sleeve 330 and the extension beam 130 about the lengthwise axis 150 in the second axial position state 255 with the pin 400 first portion 425 in an arched portion 435 of the “L” shaped key slot 405 in the first axial position state 250 with the pin 400 first portion 425 in a straight portion 430 of the “L” shaped key slot 405 of the extension beam 130 first end portion 135, see FIGS. 4 and 5.

As a continuing alternative for the lock apparatus 50, 55, wherein the outer sleeve 330 can further comprises a thumb lever 350 type manual grabbing point, see FIGS. 14 and 15, plus FIGS. 18 to 20.

As a further continuing alternative for the lock apparatus 50, 55, in referring to primarily to FIGS. 11 to 13, and secondarily to FIGS. 14 to 20, wherein the retainer 285 is preferably constructed of the key hole ramp disc 286 that includes the keyhole type slot 287 disposed therethrough the key hole ramp disc 286 wherein the keyhole type slot 287 has the first partial shoulder ridge 288 disposed on the primary side 289 of the disc 286 and the second partial shoulder ridge 291 disposed on the secondary side 292 of the disc 286 wherein the first 288 and second 291 partial shoulder ridges are positioned in an opposing manner to one another about the keyhole type slot 287. Wherein operationally the second portion 426 of the pin 400 passes therethrough the keyhole type slot 287 being rotated such that the second portion 426 of the pin 400 is to be slidably engaged to a part A 293 of the first partial shoulder ridge 288 in the second axial position state 255 and the second portion 426 of the pin 400 is slidably engaged to a part B 294 of the first partial shoulder ridge 288 in the first axial position state 250, also see FIGS. 9 and 10.

### Method of Use

Looking at FIGS. 1 to 20, a method is disclosed for using the dead bolt lock apparatus 55 for selectively securing and un-securing the door 65 to a door frame 75, comprising the steps of firstly providing the dead bolt lock apparatus 55 as previously described.

A second step of placing the twist lock assembly 225 in the first axial position state 250 via inserting the second portion 426 of the pin 400 through the keyhole type slot 287 such that the second portion 426 of the pin 400 slidably engages the part B 294 of the first partial shoulder ridge 288 to operationally rotationally engage the first element 80 secondary end portion 95 and the extension beam 130 second end portion 145 from the lock cylinder 85, see FIGS. 10, 13, and 20.

A third step of turning 245, 355, 365 the thumb lever 350 manually about the lengthwise axis 150 that turns the extension beam 130 about the lengthwise axis 150 that subsequently causes the bolt extension assembly 175 to engage the door frame 75 thus operationally securing the door 65 to the door frame 75, see FIGS. 3, 18, and 19.

As an option for the method for using the dead bolt lock apparatus 55, wherein the second placing step is reversed such that the second portion 426 of the pin 400 is selectively rotated and moved axially along the lengthwise axis 150 to be slidably engaged to the part A 293 of the second partial shoulder ridge 291 in the second axial position state 255 via moving manually the thumb lever 350 along the lengthwise axis 150 toward the lock cylinder 85 to disengage the open slot receptacle 180 and the female annular portion 185, thus placing into the second axial position state 255, thus rotationally having the lock cylinder 85 disengaged to the extension beam 130 that is engaged to the bolt extension assembly 175, see FIGS. 9, 12, 18, 19.

### Conclusion

Accordingly, the present invention of a lock apparatus has been described with some degree of particularity directed to the embodiments of the present invention. It should be appreciated, though; that the present invention is defined by the following claims construed in light of the prior art so modifications of the changes may be made to the exemplary embodiments of the present invention without departing from the inventive concepts contained therein.

1. A lock apparatus for selectively securing and un-securing a first article to a second article, said lock apparatus comprising;
(a) a first element including a primary end portion and an opposing secondary end portion with a longitudinal axis spanning therebetween, said first element having a first element rotational engagement about said longitudinal axis that is adapted to attach to the first article;
(b) an extension beam including a first end portion and an opposing second end portion with a lengthwise axis spanning therebetween, said extension beam having an extension beam rotational engagement about said lengthwise axis that is adapted to attach to the first article, wherein said lengthwise axis and said longitudinal axis are coincident to one another, wherein said extension beam second end portion has a structure to selectively rotationally engage and disengage said first element secondary end portion; and
(c) a means to selectively engage and disengage the second article that is driven from said extension beam, wherein operationally said extension beam selectively rotationally engages said first element via said structure and said extension beam selectively engages and disengages the first article to the second article, thus resulting in said extension beam always being able to selectively engage and disengage the first article to the second article and said first element only having an ability to selectively engage and disengage the first article to the second article when said first element and said extension beam are said selectively rotationally engaged to one another via said structure.

2. A lock apparatus according to claim 1 wherein said structure is constructed of an open slot receptacle that is received in a female annular portion that includes a means for urging said open slot receptacle and female annular portions apart from one another to operationally cause a default bias toward said extension beam second end portion and said first element secondary end portion being rotationally engaged, wherein manual effort is required to overcome said default bias to rotationally disengage said extension beam second end portion and said first element secondary end portion.

3. A lock apparatus according to claim 2 wherein a key is disposed on said extension beam second end portion and said open slot receptacle and female annular portion is disposed on said first element secondary end portion.

4. A lock apparatus according to claim 3 wherein said means for urging is constructed of a spring that is disposed within said female annular portion to operationally have said urging movement along said longitudinal axis.

5. A lock apparatus according to claim 1 further comprising a twist lock assembly that is adapted to be rotationally engaged to the first article, said twist lock assembly is rotationally engaged to said extension beam first end portion, said twist lock assembly having rotational movement about said lengthwise axis, said twist lock assembly having a means to removably lock a first axial position state along said lengthwise axis and use a fixed amount of rotation about said lengthwise axis to unlock said first axial position state to a second axial position state along said lengthwise axis, wherein operationally said twist lock assembly facilitates said structure to rotationally engage said first element secondary end portion and said extension beam second end portion to one another in said first axial position state and to engage said rotational engagement at said first element secondary end portion and said extension beam second end portion when in said first axial position state.

6. A lock apparatus according to claim 5 wherein said twist lock assembly further comprises a first extension element that is parallel to said lengthwise axis and a retainer that is rotationally engaged to said first extension element and is adapted to be affixed to the first article, wherein said first extension element selectively axially interlocks with a key hole ramp disc disposed within said retainer to form said first axial position state and said first extension element selectively locks with said retainer and key hole ramp disc to form said second axial position state, wherein said first extension element and said extension beam first end portion are axially affixed to one another along said lengthwise axis via an axial interface in said second axial position, wherein said first extension element is rotationally engaged to said extension beam first end portion, to operationally allow selective rotational engagement and disengagement as between said first extension element and said first element secondary end portion allowing independent engagement of said means to selectively engage and disengage the second article via said first extension element.

7. A lock apparatus according to claim 6 wherein said first extension element is respectively constructed of an outer sleeve, said extension beam first end portion is partially disposed within said outer sleeve, wherein said first extension element is said outer sleeve and said extension beam first end portion and said outer sleeve are axially and rotationally connected through a “L” shaped key slot disposed on a portion of said extension beam first end portion and a pin disposed therethrough a sidewall of said outer sleeve, wherein a first portion of said pin engages said “L” shaped key slot that operationally axially and rotationally connects said outer sleeve and said extension beam about said lengthwise axis in said second axial position state with said pin first portion in an arched portion of said L shaped key slot and in said first axial position state with said pin first portion in a straight portion of said L shaped key slot of said extension beam first end portion.

8. A lock apparatus according to claim 7 wherein said outer sleeve further comprises a thumb lever type manual grabbing point.

9. A lock apparatus according to claim 8 wherein said retainer is constructed of a key hole ramp disc that includes a keyhole type slot disposed therethrough said key hole ramp disc wherein said keyhole type slot has a first partial shoulder ridge disposed on a primary side of said disc and a second partial shoulder ridge disposed on a secondary side of said disc wherein said first and second partial shoulder ridges are positioned in an opposing manner to one another about said keyhole type slot, wherein operationally a second portion of said pin passes therethrough said keyhole type slot being rotated such that said second portion of said pin to be slidably engaged to a part A of said first partial shoulder ridge in said second axial position state and said second portion of said pin is slidably engaged to a part B of said first partial shoulder ridge in said first axial position state.

10. A dead bolt lock apparatus for selectively securing and un-securing a door to a door frame, said lock apparatus comprising;
(a) a lock cylinder including a primary end portion and an opposing secondary end portion with a longitudinal axis spanning therebetween, said lock cylinder having a rotational engagement about said longitudinal axis that is adapted to attach to the door;
(b) an extension beam including a first end portion and an opposing second end portion with a lengthwise axis spanning therebetween, said extension beam having an extension beam rotational engagement about said lengthwise axis to said lock cylinder, wherein said lengthwise axis and said longitudinal axis are coincident to one another, wherein said extension beam second end portion has a structure to selectively rotationally engage and disengage said lock cylinder secondary end portion; and
(c) a bolt extension assembly to selectively engage and disengage the door frame that is driven from said extension beam, wherein operationally said extension beam selectively rotationally engages said lock cylinder and said extension beam selectively engages and disengages the door to the door frame, thus resulting in said extension beam always being able to selectively engage and disengage the door to the door frame and said lock cylinder only having an ability to selectively engage and disengage the door to the door frame when said lock cylinder and said extension beam are said selectively rotationally engaged to one another.

11. A lock apparatus according to claim 10 wherein said structure is constructed of an open slot receptacle that is received in a female annular portion that includes a means for urging said open slot receptacle and female annular portions apart from one another to operationally cause a default bias toward said extension beam second end portion and said lock cylinder secondary end portion being rotationally engaged, wherein manual effort is required to overcome said default bias to rotationally disengage said extension beam second end portion and said lock cylinder secondary end portion.

12. A lock apparatus according to claim 11 wherein a key is disposed on said extension beam second end portion and said open slot receptacle and female annular portion is disposed on said lock cylinder secondary end portion.

13. A lock apparatus according to claim 12 wherein said means for urging is constructed of a spring that is disposed within said female annular portion to operationally have said urging movement along said longitudinal axis.

14. A lock apparatus according to claim 10 further comprising a twist lock assembly that is adapted to be rotationally engaged to the door, said twist lock assembly is rotationally engaged to said extension beam first end portion, said twist lock assembly having rotational movement about said lengthwise axis, said twist lock assembly having a means to removably lock a first axial position state along said lengthwise axis and use a fixed amount of rotation about said lengthwise axis to unlock said first axial position state to a second axial position state along said lengthwise axis, wherein operationally said twist lock assembly facilitates said structure to rotationally disengage said lock cylinder secondary end portion and said extension beam second end portion to one another in said second axial position state and to engage said rotational engagement at said lock cylinder secondary end portion and said extension beam second end portion when in said first axial position state.

15. A lock apparatus according to claim 14 wherein said twist lock assembly further comprises a first extension element that is parallel to said lengthwise axis and a retainer that is rotationally engaged to said first element and adapted to be affixed to the door, wherein said first extension element selectively axially interlocks with said retainer to form said first axial position and said first extension element selectively unlocks with a key hole ramp disc disposed within said retainer to form said second axial position state, wherein said first extension element and said extension beam first end portion are axially affixed to one another along said lengthwise axis via an axial interface in said second axial position state, wherein said first extension element is rotationally engaged to said extension beam first end portion, to operationally allow selective rotational engagement and disengagement as between said first extension element and said lock cylinder secondary end portion allowing independent engagement of said bolt extension assembly to selectively engage and disengage the door frame via said first extension element.

16. A lock apparatus according to claim 15 wherein said first extension element is respectively constructed of an outer sleeve and said extension beam first end portion that is partially disposed within said outer sleeve, wherein said first extension element is said outer sleeve and said extension beam first end portion are axially and rotationally connected through a “L” shaped key slot disposed on a portion of said extension beam first end portion and a pin disposed therethrough a sidewall of said outer sleeve, wherein a first portion of said pin engages said “L” shaped key slot that operationally axially and rotationally connects said outer sleeve and said extension beam first end portion about said lengthwise axis, in said second axial position state with said pin first portion in an arched portion of said L shaped key slot and in said first axial position state with said pin first portion in a straight portion of said L shaped key slot of said extension beam first end portion.

17. A lock apparatus according to claim 16 wherein said outer sleeve further comprises a thumb lever type manual grabbing point.

18. A lock apparatus according to claim 17 wherein said retainer is constructed of a key hole ramp disc that includes a keyhole type slot disposed therethrough said key hole ramp disc wherein said keyhole type slot has a first partial shoulder ridge disposed on a primary side of said disc and a second partial shoulder ridge disposed on a secondary side of said key hole ramp disc, wherein said first and second partial shoulder ridges are positioned in an opposing manner to one another about said keyhole type slot, wherein operationally a second portion of said pin passes therethrough said keyhole type slot being rotated such that said second portion of said pin to be slidably engaged to a part A of said first partial shoulder ridge in said second axial position state and said second portion of said pin is slidably engaged to a part B of said second partial shoulder ridge in said first axial position state.

19. A method for using a dead bolt lock apparatus for selectively securing and un-securing a door to a door frame, comprising the steps of:
(a) providing a dead bolt lock apparatus that has a lock cylinder including a primary end portion and an opposing secondary end portion with a longitudinal axis spanning therebetween, said lock cylinder having a rotational engagement about said longitudinal axis to the door, further included in the dead bolt lock apparatus is an extension beam including a first end portion and an opposing second end portion with a lengthwise axis spanning therebetween, said extension beam having an extension beam rotational engagement about said lengthwise axis to said lock cylinder, wherein said lengthwise axis and said longitudinal axis are coincident to one another, wherein said extension beam second end portion has a structure to selectively rotationally engage and disengage said lock cylinder secondary end portion, said structure is constructed of a open slot receptacle that is received in a female annular portion that includes a means for urging said open slot receptacle and female annular portions apart from one another to operationally cause a default bias toward said extension beam second end portion and said lock cylinder secondary end portion being rotationally engaged, wherein manual effort is required to overcome said default bias to rotationally disengage said extension beam second end portion and said lock cylinder secondary end portion, and a bolt extension assembly to selectively engage and disengage the door frame that is driven from said extension beam, wherein operationally said extension beam selectively rotationally engages said lock cylinder and said extension beam selectively engages and disengages the door to the door frame, thus resulting in said extension beam always being able to selectively engage and disengage the door to the door frame and said lock cylinder only having an ability to selectively engage and disengage the door to the door frame when said lock cylinder and said extension beam are said selectively rotationally engaged to one another, also said dead bolt lock apparatus has a twist lock assembly that is adapted to be rotationally engaged to the door, said twist lock assembly is rotationally engaged to said extension beam first end portion, said twist lock assembly having rotational movement about said lengthwise axis, said twist lock assembly having a means to removably lock a first axial position state along said lengthwise axis and use a fixed amount of rotation about said lengthwise axis to unlock said first axial position state to a second axial position state along said lengthwise axis, wherein operationally said twist lock assembly facilitates said structure to rotationally disengage said lock cylinder secondary end portion and said extension beam second end portion to one another in said second axial position state and to engage said rotational engagement at said lock cylinder secondary end portion and said extension beam second end portion when in said first axial position state, said twist lock assembly further comprises a first extension element that is parallel to said lengthwise axis and a retainer that is rotationally engaged to said first element and adapted to be affixed to the door, wherein said first extension element selectively axially interlocks with said retainer to form said first axial position state and said first extension element and said extension beam first end portion selectively unlocks with a key hole ramp disc disposed within said retainer to form said second axial position state, wherein said first extension element and said extension beam first end portion are axially affixed to one another along said lengthwise axis via an axial interface in said second axial position state, wherein said first extension element is rotationally engaged to said extension beam first end portion, to operationally allow selective rotational engagement and disengagement as between said first extension element and said lock cylinder secondary end portion allowing independent engagement of said bolt assembly to selectively engage and disengage the door frame via said first extension element, wherein said first extension element is respectively constructed of an outer sleeve and extension beam first end portion that is partially disposed within said outer sleeve, wherein said first extension element is said outer sleeve and said extension beam first end portion are axially and rotationally connected through a “L” shaped key slot disposed on a portion of said extension beam first end portion and a pin disposed therethrough a sidewall of said outer sleeve, wherein a first portion of said pin engages said “L” shaped key slot that operationally axially and rotationally connects said outer sleeve and extension beam first end portion about said lengthwise axis, wherein said outer sleeve further comprises a thumb lever type manual grabbing point, further said retainer is constructed of a key hole ramp disc that includes a keyhole type slot disposed therethrough said key hole ramp disc wherein said keyhole type slot has a first partial shoulder ridge disposed on a primary side of said disc and a second partial shoulder ridge disposed on a secondary side of said disc wherein said first and second partial shoulder ridges are positioned in an opposing manner to one another about said keyhole type slot, wherein operationally a second portion of said pin passes therethrough said keyhole type slot being rotated such that said second portion of said pin to be slidably engaged to a part A of said first partial shoulder ridge in said second axial position state and said second portion of said pin is slidably engaged to a part B of said second partial shoulder ridge in said first axial position state;
(b) placing said twist lock assembly in said first axial position via inserting said second portion of said pin through said keyhole type slot such that said second portion of said pin slidably engages said part B of said first partial shoulder ridge to operationally rotationally engage said first element secondary end portion and said extension beam second end portion from said lock cylinder; and
(c) turning said thumb lever manually about said lengthwise axis that turns said extension beam that subsequently causes said bolt extension assembly to engage the door frame thus operationally securing the door to the door frame.

20. A method for using a dead bolt lock apparatus according to claim 19 wherein said placing step is reversed such that said second portion of said pin is selectively rotated and moved axially along said lengthwise axis to be slidably engaged to said part A of second partial shoulder ridge in said second axial position state via moving manually said thumb lever along said lengthwise axis toward said lock cylinder to disengage said open slot receptacle and female annular portions thus rotationally having said lock cylinder disengaged to said extension beam that is engaged to said bolt extension assembly.
